(19) United States
(12) Patent Application Publication
(10) Pub. No.: US 2020/0390085 A1
(43) Pub. Date: Dec. 17, 2020

(54) Portable Hunting Blind for a Bow

(71) Applicants: Caleb Lane Thompson, Evans, CO (US); Bradley Kent Thompson, Broomfield, CO (US)

(72) Inventors: Caleb Lane Thompson, Evans, CO (US); Bradley Kent Thompson, Broomfield, CO (US)

(21) Appl. No.: 16/901,389

(22) Filed: Jun. 15, 2020

Related U.S. Application Data
(63) Continuation-in-part of application No. 29/696,294, filed on Jun. 26, 2019, now Pat. No. D895045.
(60) Provisional application No. 62/860,961, filed on Jun. 13, 2019.

(51) Int. Cl. A01M 31/02; F16B 5/12

(52) U.S. Cl. CPC A01M 31/025; F16B 5/123

(57) ABSTRACT

A portable hunting blind for a bow includes a bow attachment bracket, a stabilizer track, a blind attachment bracket, a camouflage blind, and a fastener assembly. The camouflage blind protects and hides a hunter form an animal. The camouflage blind includes a rod and a foldable panel as the foldable panel is terminally attached to the rod and the rod is terminally connected to the blind attachment bracket. The blind attachment bracket and the stabilizer track are positioned in between the camouflage panel and the bow attachment bracket that secures the portable hunting blind to a hunting bow. The bow attachment bracket is slidable mounted to the blind attachment bracket through the stabilizer track and the fastener assembly thus deploying the portable hunting blind in front of the hunter and the bow.

The current application claims a priority to the U.S. Provisional Patent application Ser. No. 62/860,961 filed on Jun. 13, 2019. The current application is filed on Jun. 15, 2020 while Jun. 13, 2020 was on a weekend.

### FIELD OF THE INVENTION

The present invention relates generally to camouflage hunting weapons such as bows. More specifically, the present invention is a structure that functions as a camouflaged blind to protect and hide the hunter from the animals that are hunted.

### BACKGROUND OF THE INVENTION

Hunting is an activity that is adored by many for purposes of food, recreation, removing predators that can be dangerous to humans or domestic animals, or trade. In order to attain a safe hunting environment, a user needs appropriate equipped with hunting gear, hunting accessories, and hunting cloths. A camouflaged hunting blind is a permanent structure and allows the hunters to hide within so that the animals are not able to visually identify the hunters. The main drawback of the permanent hunting blind is that the hunters are restricted to specific area and enable them from moving to different locations.

It is an objective of the present invention to provide a portable hunting blind for a bow so that the user is able to hide behind the portable blind and move from one location to another. More specifically, a tubular body of the present invention is easily attached to a bow thus allowing a camouflaged fabric to be attached to the tubular body. Moreover, the present invention is integrated with an adjustable length feature that allows the user to use the different bows at variable heights. The tubular body of the present invention is also integrated with a storage feature to store the camouflaged fabric thus minimizing the required storage space.

### BRIEF DESCRIPTION OF THE DRAWINGS

FIG. 1 is a rear perspective view of the present invention.

FIG. 2 is a front perspective view of the present invention.

FIG. 3 is a rear exploded view of the present invention.

FIG. 4 is an exploded view of the camouflage blind of the present invention.

FIG. 5 is a perspective view of the blind attachment bracket of the present invention.

FIG. 6 is a perspective view of the bow attachment bracket of the present invention.

FIG. 7 is a perspective view of the stabilizer track of the present invention.

### DETAIL DESCRIPTIONS OF THE INVENTION

All illustrations of the drawings are for the purpose of describing selected versions of the present invention and are not intended to limit the scope of the present invention.

The present invention is a portable hunting blind for a bow so that a hunter/user can be protected from the hunted animal for safety purpose and hidden from the hunted animal thus improving the probability of a successfully kill. The present invention is preferably utilized with a compound bow; however, the component and their configuration can be easily adapted for any other type of hunting bows without deviating the overall concept and functionality of the present invention.

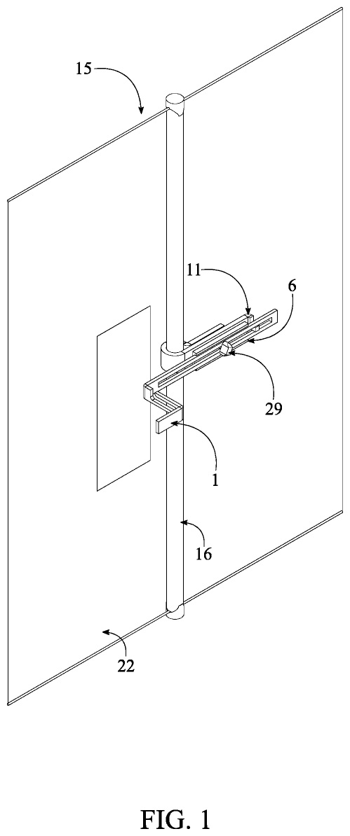

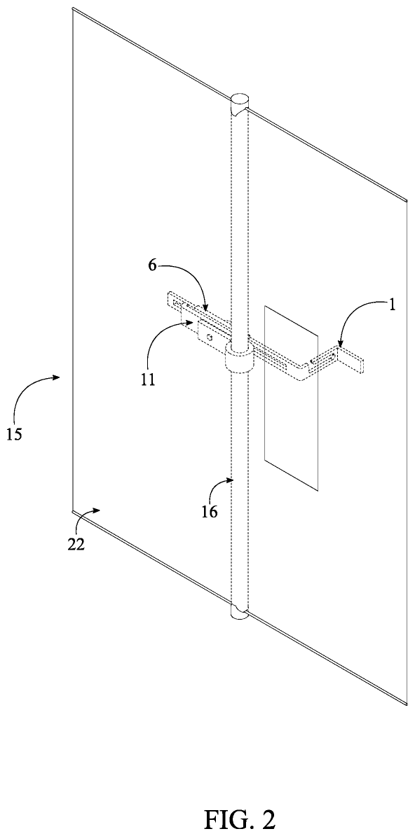

The present invention comprises a bow attachment bracket 1, a stabilizer track 6, a blind attachment bracket 11, a camouflage blind 15, and a fastener assembly 29 as shown in FIG. 1-2. In reference to a general configuration of the present invention, the camouflage blind 15 is generally positioned in front of the bow and functions as a cover for the user so that the hunted animal is not able to visually identify the user. The camouflage blind 15 comprises a rod 16 and a foldable panel 22. The foldable panel 22 is terminally attached to the rod 16 so that the camouflage blind 15 can delineate a rectangular shaped body. The rod 16 is terminally attached to the blind attachment bracket 11 thus allowing the present invention to be mounted on to the bow. The blind attachment bracket 11 and the stabilizer track 6 are positioned in between the foldable panel 22 and the bow attachment bracket 1 so that the bow can be mounted behind the camouflage blind 15. The bow attachment bracket 1 is slidable mounted to the blind attachment bracket 11 through the stabilizer track 6 and the fastener assembly 29 so that the present invention and the bow can be adjustably mounted to each other. Slidable connection between the bow attachment bracket 1 and the fastener assembly 29 also enables different types of bows to be easily attached to the present invention.

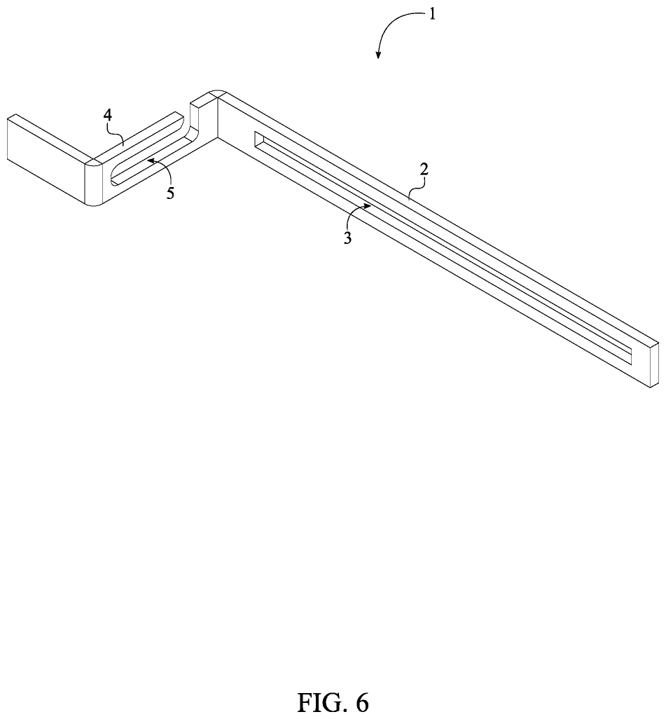

In reference to FIG. 1 and FIG. 6, the bow attachment bracket 1 is generally shaped into a L-shaped bracket so that the present invention can be horizontally moved with respect to the bow. More specifically, the bow attachment bracket 1 comprises a long section 2, an elongated opening 3, a short section 4, and a L-shaped bow receiving opening 5. The long section 2 and the short section 4 are perpendicularly positioned of each other, wherein the long section 2 is terminally connected to the short section 4 and delineates the L-shaped bracket. The elongated opening 3 traverses through the long section 2 so that the bow attachment bracket 1 can be slidably engaged with the fastener assembly 29. The L-shaped bow receiving opening 5 traverses through the short section 4 in order to receive secure the bow to the present invention. Preferably, a quiver of the bow is engaged with the L-shaped bow receiving opening 5 thus securing the bow to the short section 4.

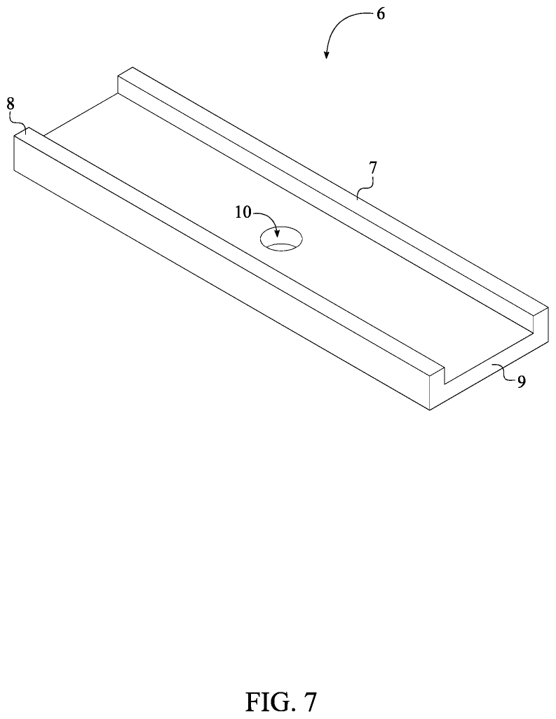

In reference to FIG. 1 and FIG. 7, the stabilizer track 6 provides stability to the horizontal movement of the bow attachment bracket 1 and comprises a first rail 7, a second rail 8, a base 9, and a fastener opening 10. More specifically, the first rail 7 and the second rail 8 are oppositely positioned of each other about the base 9. The first rail 7 is terminally connected to the base 9, and the second rail 8 is terminally connected to the base 9. Resultantly, the stabilizer track 6 is shaped into U-shaped track thus allowing the lateral sides of the long section 2 to be slidably engaged with the first rail 7 and the second rail 8. The fastener opening 10 traverses through the base 9 and centrally positioned in between the first rail 7 and the second rail 8. The fastener opening 10 provides an empty space within the stabilizer track 6 so that the fastener assembly 29 can be inserted and engaged with the stabilizer track 6.

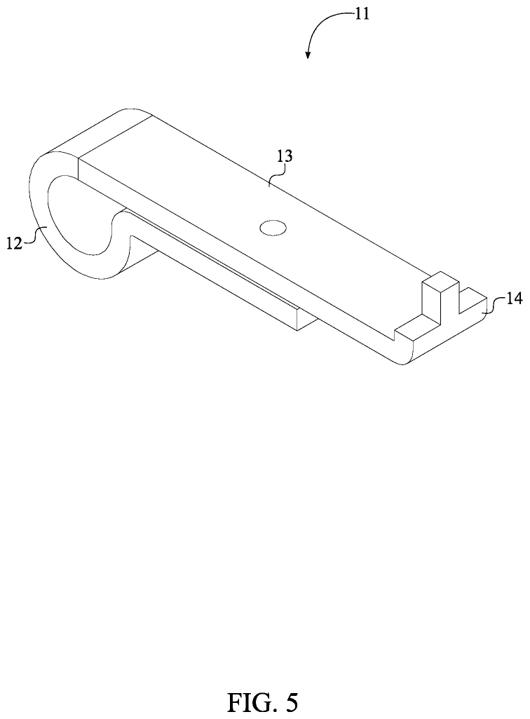

In reference to FIG. 1 and FIG. 5, the blind attachment bracket 11 that functions as the intermediate connector between the camouflage blind 15 and the stabilizer track 6 comprises a loop section 12, a support section 13, and a tongue section 14. More specifically, the loop section 12 and the tongue section 14 are oppositely positioned of each other about the support section 13 so that the camouflage blind 15 and the bow attachment bracket 1 can be offset of each other about the support section 13. The loop section 12 is terminally connected to the support section 13 so that the camouflage blind 15 can be connected to the blind attachment bracket 11. More specifically, the loop section 12 is concentrically attached around the rod 16. Preferably, the user is able to adjust the positioning of the loop section 12 along the length of the rod 16 upon user's preference and surrounding obstacles. The tongue section 14 is terminally connected to the support section 13 so that the elongated opening 3 can be slidably engaged with the tongue section 14. Furthermore, the tongue section 14 and the support section 13 are perpendicularly positioned of each other thus allowing the long section 2 to be slightly offset from the support section 13.

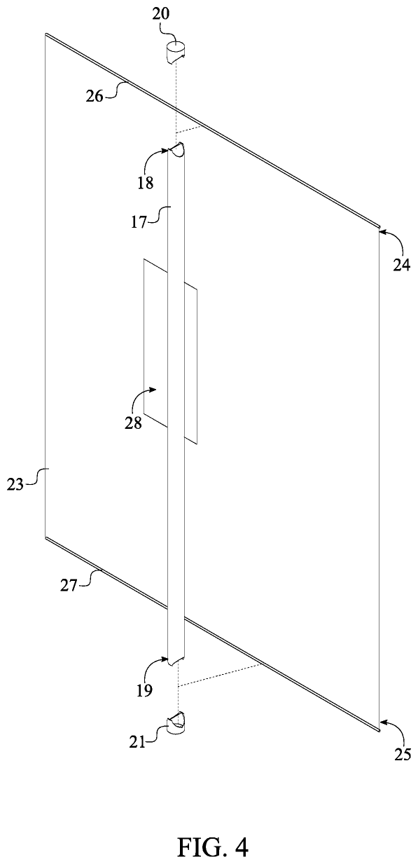

In reference to FIG. 1-4, the rod 16 comprises a tubular shaft 17, a first endcap 20, and a second endcap 21. The foldable panel 22 comprises a panel body 23, a first malleable rod 26, a second malleable rod 27, and a panel opening 28. More specifically, the first malleable rod 26 is connected to a top end 24 of the panel body 23. The second malleable rod 27 is connected to a bottom end 25 of the panel body 23. As a result, the foldable panel 22 can be stretched from top to bottom thus delineating the rectangular shape. Once the foldable panel 22 is fully expanded, the first malleable rod 26 is attached to a top edge 18 of the tubular shaft 17 through the first endcap 20. The second malleable rod 27 is attached to a bottom edge 19 of the tubular shaft 17 through the second endcap 21. In other words, the first endcap 20 presses the first malleable rod 26 against the top edge 18 so that the top end 24 of the foldable panel 22 can be attached to the rod 16. Similarly, the second endcap 21 presses the second malleable rod 27 against the bottom edge 19 so that the bottom end 25 of the foldable panel 22 can be attached to the rod 16. The panel opening 28 traverses through the panel body 23 and aligned with the short section 4 of the bow attachment bracket 1. As a result, the panel opening 28 provides an empty space within the foldable panel 22 so that a loaded arrow of the bow can be released through the foldable panel 22 and the user is able to look into the surrounding area.

The tubular shaft 17 also functions as a storage compartment for the foldable panel 22 when the present invention is not utilized for hunting purpose. More specifically, when the first endcap 20 or the second endcap 21 is removed from the tubular shaft 17, the user can access the internal storage space of the tubular shaft 17. Then, the foldable panel 22 is rolled and inserted into the internal storage space. Once the foldable panel 22 is fully inserted into the tubular shaft 17, the removed endcap can be attached back onto the tubular shaft 17 thus concealing the foldable panel 22.

Moreover, the foldable panel 22 can be designed with woodland pattern, snow pattern, and desert pattern so that the present invention can be utilized within different hunting environments upon user's preference.

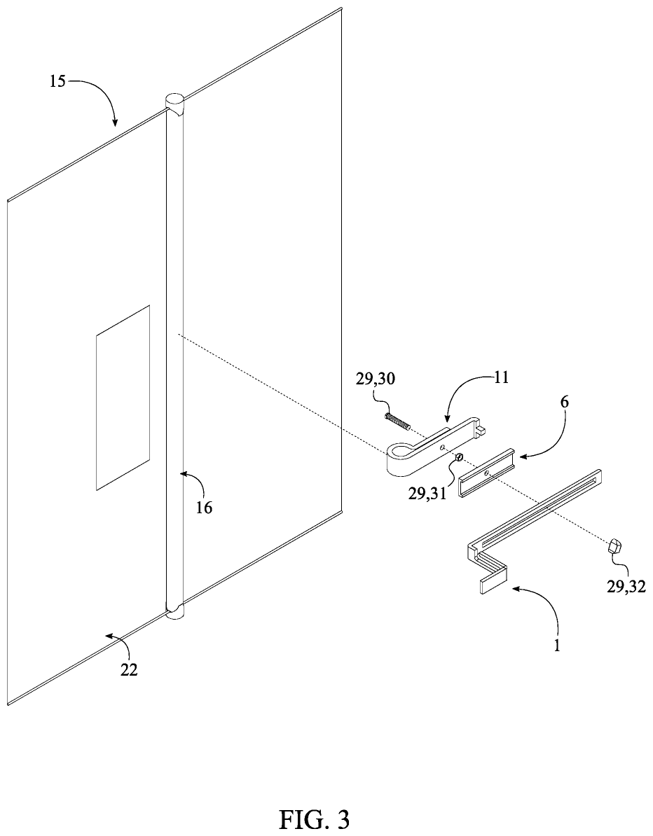

In reference to FIG. 3, the fastener assembly 29 comprises a male fastener 30, a female fastener 31, and a wing nut 32. More specifically, the male fastener 30 is connected to the support section 13 and positioned perpendicularly to the support section 13. The male fastener 30 functions as the main structural body as the female fastener 31 and the wing nut 32 are threadedly engaged with the male fastener 30. In other words, the female fastener 31 is threadedly engaged around the male fastener 30 and positioned adjacent to the support section 13. Resultantly, the female fastener 31 is able to function as a spacer between the support section 13 and the base 9 of the stabilizer track 6. The male fastener 30 is then able to traverses through the fastener opening 10 of the stabilizer track 6 and the elongated opening 3 of the bow attachment bracket 1. As a result, the engagement between the elongated opening 3 and the male fastener 30 and the engagement between the elongated opening 3 and the tongue section 14 provide two slidable connections for the long section 2. The wing nut 32 is threadedly engaged around the male fastener 30 that the base 9 of the stabilizer track 6 can be pressed against the female fastener 31 while the wing nut 32 is able pressed against the long section 2 of the bow attachment bracket 1.

Although the invention has been explained in relation to its preferred embodiment, it is to be understood that many other possible modifications and variations can be made without departing from the spirit and scope of the invention as hereinafter claimed.

What is claimed is:

1. A portable hunting blind for a bow comprising:
a bow attachment bracket;
a stabilizer track;
a blind attachment bracket;
a camouflage blind;
a fastener assembly;
the camouflage blind comprising a rod and a foldable panel;
the foldable panel being terminally attached to the rod;
the rod being terminally attached to the blind attachment bracket;
the blind attachment bracket and the stabilizer track being positioned in between the foldable panel and the bow attachment bracket; and
the bow attachment bracket being slidable mounted to the blind attachment bracket through the stabilizer track and the fastener assembly.

2. The portable hunting blind for a bow as claimed in claim 1 comprising:
the bow attachment bracket comprising a long section, an elongated opening, a short section, and a L-shaped bow receiving opening;
the long section and the short section being perpendicularly positioned of each other;
the long section being terminally connected to the short section;
the elongated opening traversing through the long section; and
the L-shaped bow receiving opening traversing through the short section.

3. The portable hunting blind for a bow as claimed in claim 1 comprising:
the stabilizer track comprising a first rail, a second rail, a base, and a fastener opening;
the first rail and the second rail being oppositely positioned of each other about the base;
the first rail being terminally connected to the base;
the second rail being terminally connected to the base; and
the fastener opening traversing through the base.

4. The portable hunting blind for a bow as claimed in claim 1 comprising:
the blind attachment bracket comprising a loop section, a support section, and a tongue section;
the loop section and the tongue section being oppositely positioned of each other about the support section;
the loop section being terminally connected to the support section;
the tongue section being terminally connected to the support section; and
the tongue section and the support section being perpendicularly positioned of each other.

5. The portable hunting blind for a bow as claimed in claim 4, wherein the loop section being concentrically attached around the rod.

6. The portable hunting blind for a bow as claimed in claim 1 comprising:
the rod comprising a tubular shaft, a first endcap, and a second endcap;
the foldable panel comprising a panel body, a first malleable rod, a second malleable rod, and a panel opening;
the first malleable rod is connected to a top end of the panel body;
the second malleable rod is connected to a bottom end of the panel body;
the first malleable rod is attached to a top edge of the tubular shaft through the first endcap;
the second malleable rod is attached to a bottom edge of the tubular shaft through the second endcap; and
the panel opening traversing through the panel body.

7. The portable hunting blind for a bow as claimed in claim 6, wherein the panel opening being aligned with a short section of the bow attachment bracket.

8. The portable hunting blind for a bow as claimed in claim 1 comprising:
the stabilizer track comprising a first rail and a second rail;
the blind attachment bracket comprising a tongue section;
a long section of the bow attachment bracket being slidably engaged within the first rail and the second rail; and
the tongue section being slidably engaged within an elongated opening of the bow attachment bracket.

9. The portable hunting blind for a bow as claimed in claim 1 comprising:
the fastener assembly comprising a male fastener, a female fastener, and a wing nut;
the male fastener being connected to a support section of the blind attachment bracket;
the male fastener being positioned perpendicularly to the support section;
the female fastener being threadedly engaged around the male fastener;
the female fastener being positioned adjacent to the support section;
the male fastener traversing through a fastener opening of the stabilizer track and an elongated opening of the bow attachment bracket;
the wing nut being threadedly engaged around the male fastener;
a base of the stabilizer track being pressed against the female fastener; and
the wing nut being pressed against a long section of the bow attachment bracket.
